(19) United States
(12) Patent Application Publication
(10) Pub. No.: US 2006/0240386 A1
(43) Pub. Date: Oct. 26, 2006

(54) Method and apparatus for oral care

(75) Inventors: Zvi Yaniv, Austin, TX (US); John Ruberto, West Palm Beach, FL (US)

Correspondence Address: WINSTEAD SECHREST & MINICK P.C., P.O. BOX 50784, DALLAS, TX, 75201, US

(73) Assignee: Nano-Proprietary, Inc., Austin, TX (US)

(21) Appl. No.: 11/405,747

(22) Filed: Apr. 18, 2006

Related U.S. Application Data
(60) Provisional application No. 60/672,323, filed on Apr. 18, 2005.

(51) Int. Cl. A61C 5/00; A61C 3/00

(52) U.S. Cl. 433/215; 204/157.15; 422/186; 433/29

(57) ABSTRACT

One embodiment of the invention comprises an oral care system that comprises a photocatalytic solution. The photocatalytic solution may comprise titanium oxide nanotubes. The system may also include an oral instrument that is coupled to a light source. The photocatalytic solution will degrade oral pollutants upon exposure to illumination from the light source. The photocatalytic solution may be disposed, for example, within, on or about a dentifrice. The titanium oxide nanotubes may be rectangular in cross-section, anatase in form and less than 500 nm in width, less than 500 nm in length, and less than 5000 nm in height.

### CROSS-REFERENCE TO RELATED APPLICATIONS

This application relates to and claims priority from provisional patent application No. 60/672,323, filed on Apr. 18, 2005, entitled “Method and Apparatus for Oral Care”, which is hereby incorporated by reference.

### BACKGROUND INFORMATION

1. Technical Field

The present invention relates to apparatuses and methods for providing oral care to patients.

2. Description of the Related Art

Many humans and animals suffer from a variety of oral ailments. Stained teeth are one such problem caused by, for example, exposing the teeth to extrinsic factors (e.g., tobacco, coffee, tea) and pigment generating bacteria. Halitosis, tooth decay and gum irritation are also common ailments.

These ailments may be treated by using photocatalytic substances. When a photocatalytic substance, such as titanium dioxide, is irradiated by light having, for example, the band-gap energy of the photocatalytic material (e.g., when titanium dioxide is irradiated by ultraviolet light having a wavelength of about 400 nm or less), electrons present in the valence electron band of the substance are excited and migrate to the conduction band. Thus, free electrons are generated in the conduction band. At the same time, positively-charged particles (i.e., positive holes) are generated in the valence band. These positive holes and free electrons move in the semiconductor photocatalytic substance and later recombine over time. When a compound is exposed to such positive holes and free electrons, the positive holes and free electrons migrate into the exposed compound.

As a result, the positive holes can directly oxidize the exposed compound or produce hydroxide-group radicals, one form of activated oxygen. The free electrons can cause reduction reactions whereby the free electrons add to oxygen to produce oxygen species having an oxidizing capability. Thus, when light is irradiated onto a photocatalytic photo-semiconductor, the photocatalyst forms an oxidative activated surface to act as a catalyst for the decomposition, or the like, of organic compounds. In short, photocatalysts can reduce certain toxins into harmless water and carbon dioxide.

Among photo-semiconductor photocatalysts, titanium dioxide exhibits an extremely high oxidizing catalytic action when used in fine particulate form. Titanium dioxide is also superb in terms of stability and safety. Titanium dioxide may be processed to a fine powder, and the fine powder may be applied as a film on a surface of a substrate. As described above, when the photocatalyst is irradiated by ultraviolet light, it exhibits a high oxidizing capability which can be utilized to decompose organic compounds, etc.

Another method of applying photocatalysts entails a sol-gel process whereby titanium dioxide is dissolved in a liquid solution that coats the substrate and is subsequently calcimined at elevated temperatures to provide a crystal structure at the surface. When the photocatalyst is irradiated by ultraviolet light, it exhibits a high oxidizing capability which can be utilized to decompose organic compounds. The oxidation efficiency may be dependent on an even distribution of the illumination on the catalyst, the surface area of the catalyst to be illuminated, and an even distribution of the reactant to be oxidized.

The titanium dioxide may exist in the form of a dentifrice. The titanium dioxide may be distributed within the dentifrice in a powder form comprising nanoparticles ranging in size from 5-60 nanometers. However, the titanium dioxide may also be in a sol-type form. Furthermore, the titanium dioxide may be of anatase, rutile, or brookite structure as well as other forms of crystalline structure. The viscosity of the dentifrice may range from 1,000-100,000 centipoise. Some embodiments may have a viscosity range of 5,000-50,000 centipoise.

In addition to treating the discoloration of teeth, photocatalytic semiconductors may be used to deodorize, clean, sterilize and purify air in the interiors of rooms and cabins of automobiles, trains, ships and the like. Accordingly, attention has been drawn to photocatalytic systems for the purification of an air stream in these environments. One example of a device using photocatalytic action of a semiconductor for removing odors and purifying air consists of a deodorizing lamp. Toada et al., U.S. Pat. No. 5,650,126, discloses a deodorizing lamp having a lamp coated with a titanium oxide film and one or more metals selected from the group comprising iron, platinum, rhodium, ruthenium, palladium, silver, copper, zinc, and manganese.

Such purification of air is promoted because ultraviolet light, at, for example, the germicidal wavelength of about 253 nanometers, alters the genetic (DNA) material in toxin cells so that bacteria, viruses, molds, algae and other microorganisms can no longer reproduce. The microorganisms are considered dead and the risk of disease from them is reduced. As the air flows past the UV lamps in UV disinfection systems, the microorganisms are exposed to a lethal dose of UV energy. UV dose may be measured as the product of UV light intensity times the exposure time within the UV lamp array. UV energy that is approximately 34,000 microwatt-seconds/cm² in intensity can destroy pathogens. Some disinfection systems and devices emit UV light at approximately 254 nm (which penetrates the outer cell membrane of microorganisms) which allows energy to pass through the cell body, reach the DNA and alter the genetic material of the microorganism, thus destroying the microorganism without chemicals by rendering it unable to reproduce. Ultraviolet light can be classified into three wavelength ranges: UV-C, from about 200 nanometers (nm) to about 280 nm; UV-B, from about 280 nm to about 315 nm; and UV-A, from about 315 nm to about 400 nm.

Thus, the photocatalyst decomposes organic compounds, unpleasant-odor components, and organic substances being brought into contact therewith by means of the oxidizing catalytic reaction, or it destroys or inhibits germs, like fungi or bacteria, from growing. The organic compounds to be decomposed may be sulfur-including organic compounds (e.g., hydrogen sulfide and mercaptan), nitrogen-including organic compounds (e.g., trimethylamine and propylamine), nitrogen oxides and hydrocarbons (e.g., toluene and xylene). The unpleasant odor components to be decomposed may be aldehydes or carboxylic acids, such as butyric acid and n-pentanoic acid. The organic substances to be decomposed may be cigarette tar. Therefore, the photocatalyst may keep purifying air in the inside of houses or the passenger compartment of automobiles by deodorizing, reducing germs, and inhibiting germs from growing.

To promote air purification, photocatalyzers can be disposed on adhesive layers of a substrate that is then affixed to walls of kitchens, bathrooms and lavatories which can be subjected to ultraviolet irradiation, or on furniture in order to purify ambient air and simultaneously inhibit germs from growing. In order to withstand the oxidizing action resulting from the photocatalyst, such as titanium oxide, the matrix or binder for holding the titanium oxide may be a highly oxidation-resistant substance. From this viewpoint, the substance for holding the titanium dioxide may be an oxidation-resistant synthetic resin, such as a fluorocarbon resin or a silicone resin, or an oxidation-resistant inorganic adhesive, such as silicate or phosphate.

Titanium dioxide can be formed as a thin film by a physical vapor deposition process, or a chemical vapor deposition process. If such is the case, a binder may not be required. However, a base layer for holding a titanium-dioxide vapor-deposition film may be required to be highly oxidation-resistant. Accordingly, in order to prepare the substrate, the base layer may be formed of a fluorocarbon resin or a silicone resin, and a titanium-dioxide vapor-deposition film can be disposed on one of the opposite surfaces of the base layer. In particular, when a base layer must have exceptionally strong oxidation resistance, an inorganic cloth can be used as a base layer. The inorganic cloth can be knitted or woven with an inorganic fiber like a glass fiber. On the inorganic-cloth base layer, a titanium-dioxide vapor-deposition film can be formed, or a top layer can be formed by using a fluorocarbon resin or a silicone resin in which a titanium dioxide powder is compounded.

The titanium oxide itself maybe used in various forms. For example, nano-size metal particles of at least one type of metal may be deposited into carbon nanotubes. The nanotubes may take various shapes such as the C60 buckminsterfullerene or a (10, 10) tube. To remove impurities from air flowing through a filter, nano-sized metal particles selected from among copper (Cu), platinum (Pt), and nickel (Ni) may be deposited into each pore of the carbon nanotubes, thereby enhancing the removal of hazardous materials of the filter. In addition, to sterilize air flowing through the filter, nano-sized metal particles selected from among silver (Ag), aluminum (Al), copper (Cu), iron (Fe), zinc (Zn), cadmium (Cd), palladium (Pd), rhodium (Rh), and chrome (Cr) may be deposited into the pores of the carbon nanotubes. Further, nano-sized metal particles of titanium dioxide, vanadium (V), zinc (Zn), or gold (Au) may be used to enhance deodorization properties of the filter.

A functional filter may be prepared by incorporating a specific material for air purification into micropores of carbon nanotubes, thus exhibiting various functions of deodorization, sterilization and removal of impurities. That is, a filter may have different removing functions based on the functional material confined in the micropores of the carbon nanotubes. For instance, when titanium dioxide is confined in the carbon nanotubes, a deodorization function is enhanced. Use of silver (Ag) results in an increased sterilization function, while use of nickel (Ni) may lead to increased removal function of impurities such as volatile organic compounds (VOCs). In short, the functional filter may incorporate any of the aforementioned or later-described photocatalytic embodiments (e.g., rectangular-column nanostructured titanium oxide).

### SUMMARY DESCRIPTION

One embodiment of the invention comprises an oral care system that comprises a photocatalytic solution. The photocatalytic solution may comprise titanium oxide nanotubes. The system may also include an oral instrument that is coupled to a light source. The photocatalytic solution will degrade oral pollutants upon exposure to illumination from the light source. The photocatalytic solution may be disposed, for example, within, on or about a dentifrice, oral rinse, dental floss or a tablet (e.g., chewing gum, breath mint). The titanium oxide nanotubes may be rectangular in cross-section, anatase in form and less than 500 nm in width, less than 500 nm in length, and less than 5000 nm in height.

The oral instrument may comprise a night guard with a translucent portion for transmitting light from a light source to the oral cavity. In other embodiments of the invention, the oral instrument may be a toothbrush. The toothbrush may comprise a translucent portion for transmitting light from a light source to the oral cavity. The light source may comprise an ultraviolet light source.

Another embodiment of the invention may comprise an oral care instrument comprising a body, a translucent segment or portion, and a port that may be operatively coupled to a light source. When a photocatalytic solution is applied to a patient's oral cavity, oral pollutants located within the cavity may be degraded upon exposure to illumination from the light source. The oral care instrument may include a night guard or toothbrush. The light source may comprise an ultraviolet light source.

In another embodiment of the invention, a method for providing oral care may be practiced. The method's steps include applying a photocatalytic solution within an oral cavity of a patient. The photocatalytic solution may comprise titanium oxide nanotubes. Another step includes illuminating the solution with light from an oral instrument this is coupled to a light source. Another step includes degrading oral pollutants upon exposing the oral cavity to illumination from the light source.

In one embodiment of the invention, the solution is illuminated overnight. In some embodiments of the invention, a step includes mechanically agitating the solution with an oral instrument such as a tooth brush. In some embodiments of the invention, the solution may be applied to the oral cavity using dental floss that is coated in the solution. In an alternative embodiment of the invention, a step includes applying the solution within the oral cavity using a night guard.

The foregoing has outlined rather broadly the features of the present invention in order that the detailed description of the invention that follows may be better understood. Additional features and advantages of the invention will be described hereinafter, which form the subject of the claims of the invention.

### BRIEF DESCRIPTION OF THE DRAWINGS

For a more complete understanding of the present invention, and the advantages thereof, reference is now made to the following description taken in conjunction with the accompanying drawings, in which:

FIG. 1 is a picture of a photocatalyst that uses a binder.

FIG. 2 is a picture of a photocatalyst of anatase type.

FIG. 3 is a diagram of embodiment of the invention using nanostructured titanium oxide.

FIG. 4 is a graph of test results for a nanostructured titanium oxide.

FIG. 5 is a graph of test results for a nanostructured titanium oxide.

FIG. 6 is a graph of test results for a nanostructured titanium oxide.

FIG. 7 is a side view of one embodiment of the invention.

FIG. 8 is a side view of one embodiment of the invention.

FIG. 9 is a flow chart describing steps in one embodiment of the invention.

### DESCRIPTION OF THE PREFERRED EMBODIMENT(S)

In one embodiment of the invention, a container may be, for example, hermetically sealed. The container may be lined, internally or externally, with any of the aforementioned or later-described photocatalytic embodiments (e.g., rectangular-column nanostructured titanium oxide). The container may further incorporate a light source to activate the photocatalytic substance. The container can then attach to a household or industrial vacuum cleaner. The photocatalytic material may be coupled to a woven material, as described above. The light source may irradiate the photocatalyst using, for example, a fiber optic embodiment whereby the light source and fiber optic cable lies adjacent to the woven material or is interwoven with the material. Furthermore, the fiber optic material may comprise the woven container with, for example, a photocatalyst applied to the fiber optic source. Such embodiments may be useful in purifying environments such as household carpets or industrial settings wherein, for example, a material such anthrax may be present. The need for such an invention is of significant import in light of the increasingly present threat of bioterrorism. While woven embodiments are described above, non-woven embodiments are clearly addressed as well. For example, a container incorporating translucent plastic may be coated in a photocatalytic substance. Irradiating light, UV or otherwise, may be shown upon the outer surface of the translucent container, thereby irradiating the photocatalyst present on the inside of the container. The photocatalyst need not line the surface of the container. It may also or otherwise be sprayed into the container on demand or at predetermined intervals. The container may incorporate exhaust systems or circulation systems to better mix the photocatalyst with toxins and then, for example, disperse purified air once sensors indicate the level of toxin is safe. Incorporated by reference is U.S. Patent Application 60/624,724, whereby a photocatalytic process is described and includes, for example, air, water and environmental purification systems.

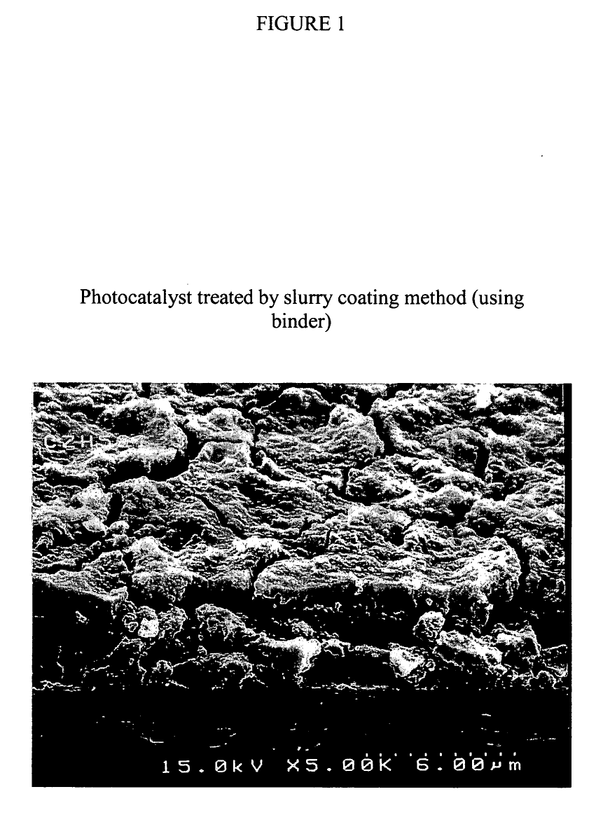

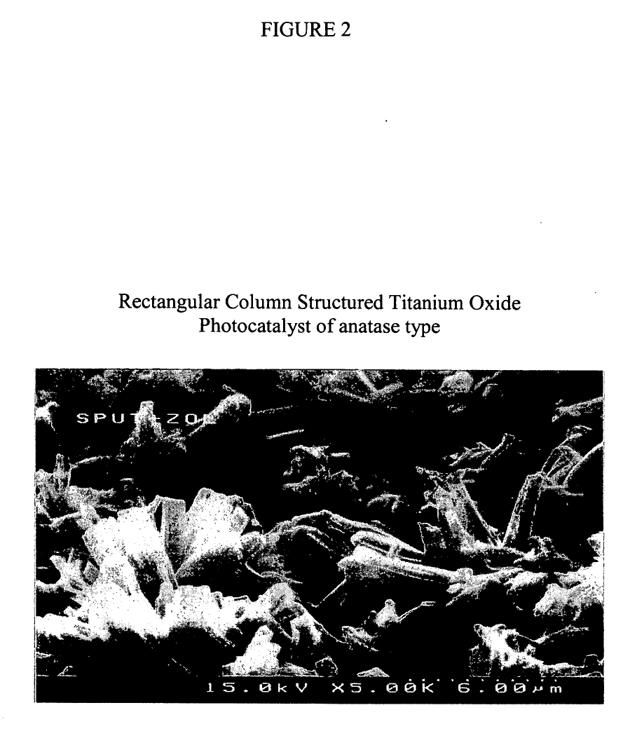

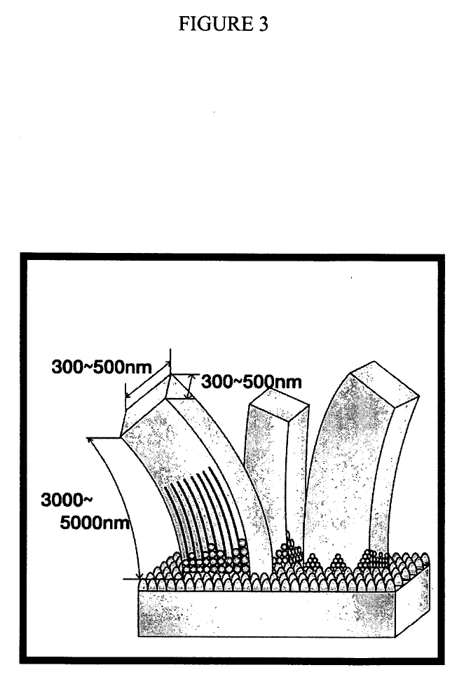

Photocatalysts may also be used as a general mouth cleanser and disinfectant. The cleanser can be used to whiten teeth and clean breath by disabling viruses, bacteria and toxins. In one embodiment of the invention, a photocatalyst can be deposited within a dentifrice. The titanium dioxide may exist in a form whereby the photocatalyst is treated with a slurry coating method using a binder (FIG. 1). In addition, the photocatalyst may exist in a rectangular-column nano-structure titanium oxide (FIGS. 2 and 3). The rectangular-column nanostructured shape provides a wider relative surface area and higher efficiency to promote better photocatalytic action. Incorporated by reference is patent application WO 2004/026471 A1, whereby a method for creating rectangular-column nano-structure titanium oxide is described.

Furthermore, the titanium dioxide may be deposited within the dentifrice without the use of binders. Incorporated by reference is Takeshi Kudo, Yuko Nakamura and Auma Ruike, Development of Rectangular Column Structured Titanium Oxide Photocatalysts Anchored on Silica Sheets, Res. Chem. Intermed., Vol. 29, No. 6, pp. 631-639 (2003), whereby a method for anchoring photocatalysts to a substrate without binders is described. Avoiding binders allows for a higher effectiveness of the photocatalysts.

In addition, by limiting the titanium dioxide to its anatase crystalline form, the decomposing ability of the photocatalyst is heightened compared to that of ordinary metal titanium dioxide powders. When the dentifrice is then illuminated and applied to the tooth and then irradiated with ultraviolet light, a photocatalytic reaction takes place. If the dentifrice is allowed to stay on the tooth for a short period of time, viruses, bacteria and toxins responsible for stained teeth, poor oral hygiene and halitosis will be significantly reduced.

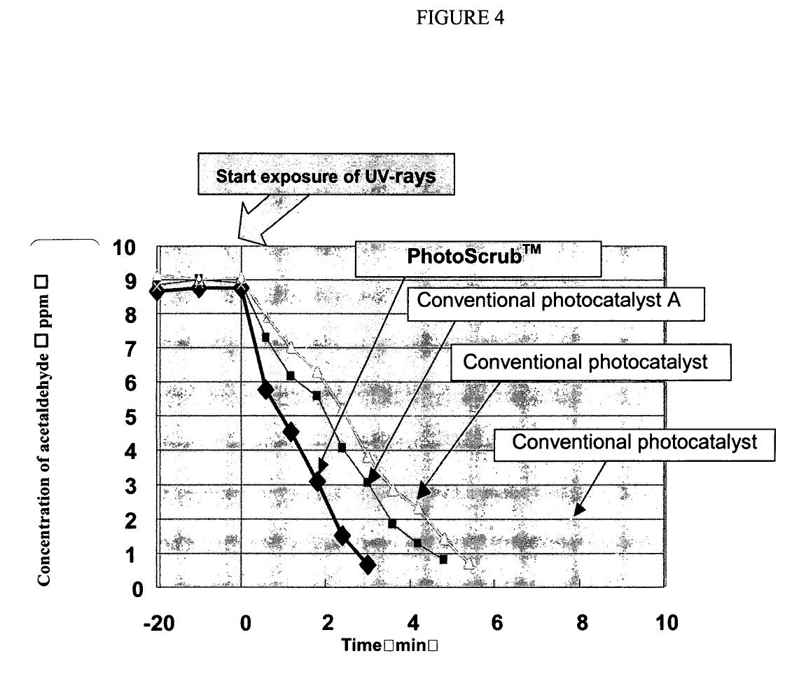

FIG. 4 illustrates how, when using rectangular-column nano-structure titanium oxide, the level of harmful gases and foul odors may be greatly reduced in a short amount of time. The photocatalyst is highly effective for many toxic organic chemicals, as well as various biological contaminants with a greater than 99% effectiveness.

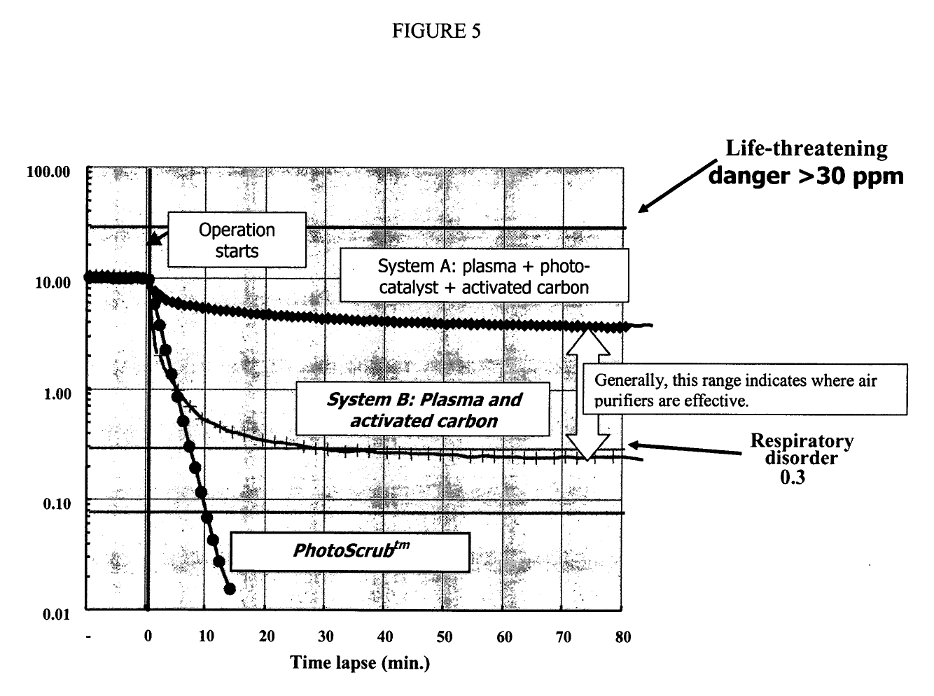

FIG. 5 illustrates how rectangular-column nano-structure titanium oxide can decompose formaldehyde to a level unachievable by other methods or air purification.

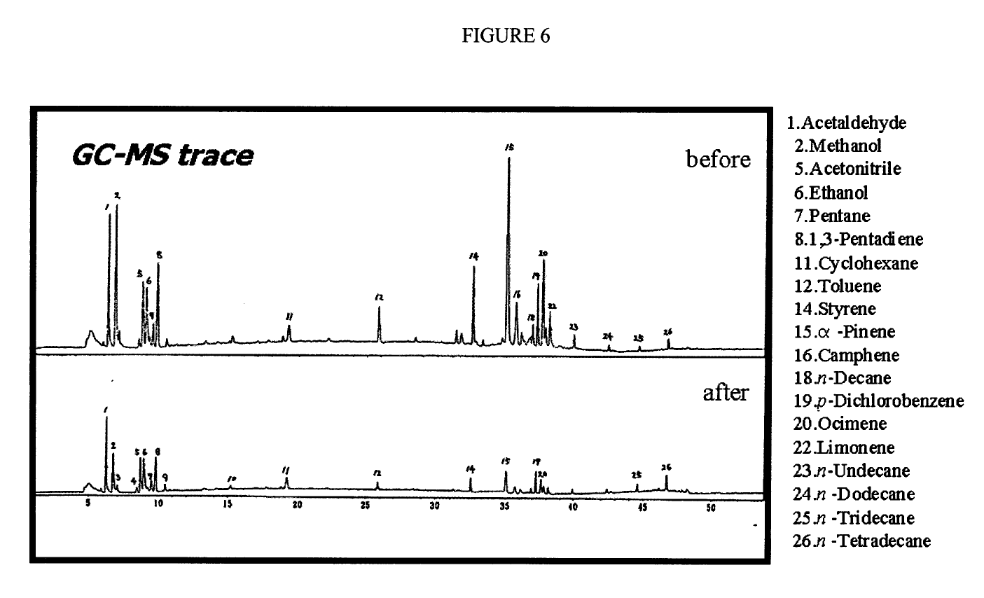

FIG. 6 shows GC-MS test results whereby rectangular-column nano-structure titanium oxide are shown to greatly reduce the level of harmful organic compounds and foul odors in a short period of time. Escherichia coli has an elimination rate of 99.95%. MRSA (Methicillin resistant staphylococcus aureus) has an elimination rate of 99.94%. Influenza virus A has an elimination rate of 99.00%.

The dentifrice may have titanium dioxide nanotubes. After being applied to the teeth, the dentifrice may be irradiated using a toothbrush that has a light, such as a light emitting diode, deposited at the head of the brush. The light may be UV and/or, for example, normal visible light. The light may shine upon the teeth and oral cavity while a user brushes his or her teeth. The body of the toothbrush may be composed of a translucent material whereby a light source, incorporated in the handle of the device, may disperse light along the entire body of the brush. As another example, the light may project from the head of the toothbrush and/or project through bristles of the toothbrush. The bristles may illuminate because they are composed of a fiber optic material. Consequently, the photocatalyst may be illuminated in difficult-to-reach areas that are better accessed by the bristles of the brush. The light may provide for irradiation of the photocatalyst as well as facilitating a general visual inspection of the oral cavity.

In another embodiment of the invention, a photocatalyst may be applied to dental floss in, for example, a powder form. Rectangular-column nano-structure titanium oxide may be applied to the dental floss in addition or instead of, for example, globular forms of photocatalyst. After flossing between the teeth, and thereby depositing the photocatalyst within the mouth, ultraviolet radiation may help reduce bacteria, viruses and toxins found therein. The use of different binders, or a lack thereof, may facilitate how easily the photocatalyst is transferred from the dental floss to the mouth, gums and teeth.

The photocatalyst may also be suspended in an oral rinse (e.g., oral spray, oral wash, mouthwash) that can be applied to the mouth and then illuminated with ultraviolet light. The light source may be incorporated within a probe that is inserted in the mouth. Furthermore, the photocatalyst can be deposited within a paste which then can be applied to the mouth and/or applied within a night guard which then can be fitted to the teeth much like a mouthpiece utilized by players in athletic events. The night guard may be fitted with a LED or other light source that provides for ultraviolet or other forms of radiation. Within the night guard, bristles may project out from the mouth guard to lie in direct contact with the teeth and surrounding gums and tissue of the mouth. These bristles may illuminate provided they are constructed of, for example, fiber optic material. The paste containing a photocatalyst could be applied into the night guard and over the bristles. Also, the bristles may be coated in a more permanent fashion with a photocatalyst slurry. Furthermore, use of said nightguard may be applied after use of the aforementioned photocatalyst-coated dental floss to facilitate illumination in locales that can be difficult to illuminate-such as locations between teeth and locations between teeth and gums.

Furthermore, the photocatalyst may be deposited within a tablet (e.g., chewing gum, breath mints, lozenges). The photocatalyst may then be administered to the mouth by chewing or consuming the tablet.

Illumination times for the aforementioned embodiments may range from instantaneous illumination, to one, three or five minutes of illumination, to overnight illumination using, for example, the nightguard. Any of the aforementioned embodiments may incorporate a timer to indicate when, for example, irradiation has occurred for one minute. Many photocatalysts, such as a lower energy band titanium oxide, are excited by visible light. Therefore, various embodiments of the invention may not utilize UV light but instead use, for example, other wavelengths of light including visible light.

In addition to or in place of the aforementioned use of a temporal timer, a sensor may be incorporated within the night guard or toothbrush that indicates when the level of aldehydes has been reduced to a predetermined level.

Photocatalytic materials other than, or in combination with, titanium oxide may be utilized such as: WO₃, WO₂, LaRhP₃, FeTiO₃, Fe2O₂, CdFe₂ O₄, SrTiO₃, CdSe, GaAs, GaP, RuO.sub.2, ZnO, ZnS, CdS, MoS₃, LaRhO₃, CdFeO₃, Bi2O₃, MoS₂, O₃, CdO, SnO₂, PtTiO₂ etc. Fe₁O₃, CdS, MoS₃, Bi₂O₃, In₂O₃, etc. With regard to raw material cost, TiO₂, Fe₂O₃ and ZnO are excellent among the above-mentioned materials.

One embodiment (FIG. 7) of the invention comprises an oral care system 700 that comprises a photocatalytic solution 710. The photocatalytic solution may comprise titanium oxide nanotubes. The system may also include an oral instrument 720 that is coupled to a light source 730. The photocatalytic solution will degrade oral pollutants upon exposure to illumination from said light source. The photocatalytic solution may be, for example, disposed within, on or about a dentifrice 710. The titanium oxide nanotubes may be rectangular in cross-section, anatase in form and less than 500 nm in width, less than 500 nm in length, and less than 5000 nm in height.

In some embodiments of the invention, the solution is provided in, on or about an oral rinse, dental floss or a tablet (e.g., chewing gum, breath mint).

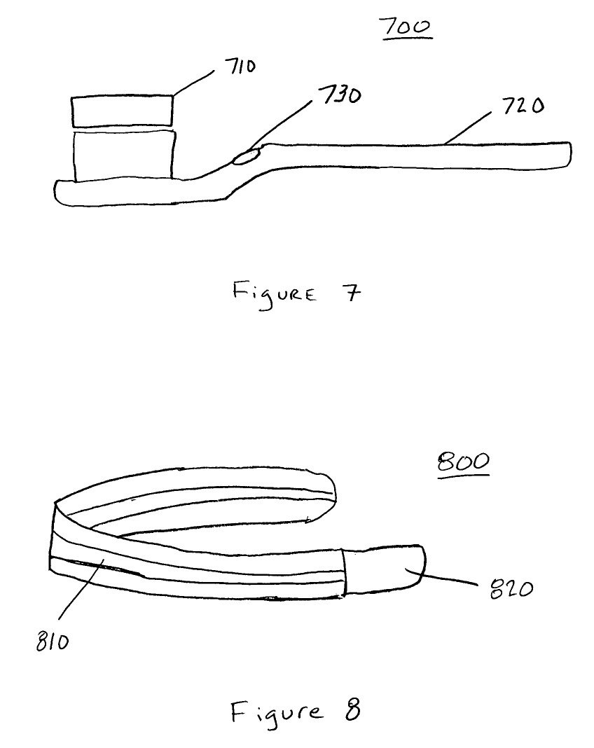

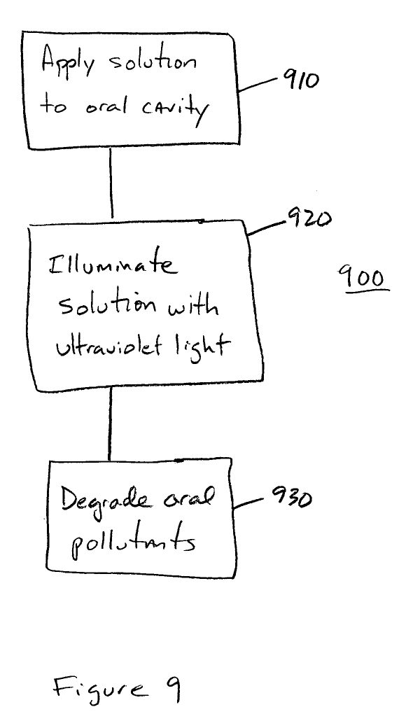

FIG. 8 discloses an oral instrument that comprises a night guard 800 with a translucent portion 810 for transmitting light from a light source 820 to the oral cavity. The light source may provide ultraviolet light.

In other embodiments of the invention, the oral instrument may be a toothbrush. The toothbrush may comprise a translucent portion for transmitting light from a light source to the oral cavity. The light source may comprise an ultraviolet light source.

Another embodiment of the invention may comprise an oral care instrument comprising a body, a translucent portion (i.e., segment), and a port that may be operatively coupled to a light source. When a photocatalytic solution is applied to a patient's oral cavity, oral pollutants located within the cavity may be degraded upon exposure to illumination from said light source. The oral care instrument may include a night guard or toothbrush. The light source may comprise an ultraviolet light source.

FIG. 9 discloses an embodiment of a method for providing oral care 900. The method's steps include applying a photocatalytic solution within an oral cavity of a patient 910. The photocatalytic solution may comprise titanium oxide nanotubes. Another step includes illuminating the solution with light from an oral instrument this is coupled to a light source 920. The light may be ultraviolet light. Another step includes degrading oral pollutants upon exposing the oral cavity to illumination from the light source 930.

In one embodiment of the invention, the solution is illuminated overnight. In some embodiments of the invention, a step includes mechanically agitating the solution with an oral instrument such as a tooth brush. In some embodiments of the invention, the solution may be applied to the oral cavity using dental floss that is coated in the solution. In an alternative embodiment of the invention, a step includes applying the solution within the oral cavity using a night guard. The light source may comprise an ultraviolet light source.

It will be understood that certain of the above-described structures, functions and operations of the above-described embodiments are not necessary to practice the present invention and are included in the description simply for completeness of an example embodiment or embodiments. In addition, it will be understood that specific structures, functions and operations set forth in the above-referenced patents and publications can be practiced in conjunction with the present invention, but they are not essential to its practice. It is therefore to be understood that the invention may be practiced otherwise than as specifically described without actually departing from the spirit and scope of the present invention. Finally, all patents, publications and standards referenced herein are hereby incorporated by reference.

What is claimed is:

1. An oral care system comprising:
a photocatalytic solution, said photocatalytic solution comprising titanium oxide nanotubes; and
an oral instrument, said instrument operatively coupled to a light source;
wherein said photocatalytic solution substantially degrades oral pollutants upon exposure to illumination from said light source.

2. The oral care system of claim 1, wherein said photocatalytic solution is disposed substantially within a medium chosen from the group consisting of a dentifrice, an oral rinse, a dental floss and a tablet.

3. The oral care system of claim 1, wherein said titanium oxide nanotubes are substantially rectangular in cross-section and substantially anatase in form.

4. The oral care system of claim 1, wherein said titanium oxide nanotubes are substantially less than 500 nm in width, substantially less than 500 nm in length, and substantially less than 5000 nm in height.

5. The oral care system of claim 1, wherein said oral instrument comprises a night guard that further comprises a substantially translucent portion for transmitting light from said light source to the oral cavity.

6. The oral care system of claim 1, wherein said oral instrument comprises a toothbrush.

7. The oral care system of claim 6, wherein said toothbrush comprises a substantially translucent portion for transmitting light from said light source to the oral cavity.

8. The oral care system of claim 1, wherein said light source comprises an ultraviolet light source.

9. An oral care solution comprising titanium oxide nanotubes, wherein said solution substantially degrades oral pollutants upon exposure to illumination from a light source.

10. The oral care solution of claim 9, said nanotubes being substantially rectangular in cross-section.

11. The oral care solution of claim 9, said nanotubes being substantially anatase in form.

12. The oral care solution of claim 9, said solution comprising a medium selected from the group consisting of a dentifrice, an oral rinse and a dental floss.

13. The oral care solution of claim 9, wherein said titanium oxide nanotubes are substantially less than 500 nm in width, substantially less than 500 nm in length, and substantially less than 5000 nm in height.

14. The oral care solution of claim 9, said solution not comprising binders.

15. An method for providing oral care comprising:
applying a photocatalytic solution within an oral cavity of a patient, said photocatalytic solution comprising titanium oxide nanotubes;
illuminating said solution with light from an oral instrument, said instrument operatively coupled to a light source; and
degrading oral pollutants upon exposing said oral cavity to illumination from said light source.

16. The method of claim 15, further comprising the step of illuminating said solution substantially overnight.

17. The method of claim 15, further comprising the step of mechanically agitating said solution with said oral instrument, said instrument comprising a tooth brush.

18. The method of claim 15, further comprising the step of applying said solution within said oral cavity using dental floss, said floss comprising said solution.

19. The method of claim 15, further comprising the step of applying said solution within said oral cavity using said oral instrument, said oral instrument comprising a night guard.

20. The method of claim 15, wherein said light source comprises an ultraviolet light source.
